(19) United States
(12) Patent Application Publication
(10) Pub. No.: US 2022/0188274 A1
(43) Pub. Date: Jun. 16, 2022

(54) FILE PROCESSING METHOD AND APPARATUS BASED ON ONLINE WORKING SYSTEM, AND STORAGE MEDIUM

(71) Applicants: UNIORANGE INTERNET DESIGN CO., LTD., Yantai (CN); BEIJING UNIORANGE TECHNOLOGY CO., LTD., Beijing (CN)

(72) Inventors: Jiadong PAN, Yantai (CN); Zenghua ZHANG, Yantai (CN); Feng WU, Beijing (CN); Jinlin XIE, Beijing (CN); Xiujuan ZHAO, Yantai (CN); Xiangyuan JI, Beijing (CN); Yang SHI, Beijing (CN)

(73) Assignees: UNIORANGE INTERNET DESIGN CO., LTD., Yantai (CN); BEIJING UNIORANGE TECHNOLOGY CO., LTD., Beijing (CN)

(21) Appl. No.: 17/317,544

(22) Filed: May 11, 2021

(30) Foreign Application Priority Data
Dec. 11, 2020 (CN) 202011462633.6

(51) Int. Cl. G06F 16/178; G06F 16/13

(52) U.S. Cl. CPC G06F 16/178; G06F 16/13

(57) ABSTRACT

Disclosed are a file processing method and apparatus based on an online working system, and a storage medium. The method is applicable to a virtual application server, and includes: performing an interaction with a virtual application client of a terminal device and launching an application according to the interaction; and obtaining and opening, in the application, a file managed by the online working system based on browser/server architecture, and sending an interface in which the file is opened to the terminal device. The online working system is deployed on an online working system server. And the obtaining the file includes: transmitting the file from a first storage device related to the online working system server to a second storage device related to the virtual application server.

For all purposes, the present application claims priority of the Chinese Patent Application No. 202011462633.6, filed on Dec. 11, 2020 and entitled “File Processing Method and Apparatus Based on Online Working System, and Storage Medium”, the disclosure of which is incorporated herein by reference in its entirety as part of the present application.

### TECHNICAL FIELD

Embodiments of the present disclosure relate to a file processing method and apparatus based on an online working system, and a storage medium.

### BACKGROUND

In the research and development (R&D) process of complex industrial products, members in an R&D team organized across enterprises and regions must cooperate with one another to conduct the research and development when solving technical problems and confirming the follow-up work. However, the corporate R&D personnel sometimes not only need to share and cooperate with internal members, but also need to carry out R&D data exchange, solution appraisal, technical communication and other activities with external collaborative members (such as experts, customers, suppliers, etc.). If the computer of the R&D personnel is not installed with computer aided design (CAD) software commonly used by the collaborative members, the data of a designed product may not be viewed, quoted and referenced by each other in real time, which will cause difficulties in the cooperation between the R&D personnel and the collaborative members.

### SUMMARY

At least some embodiments of the present disclosure provides a file processing method based on an online working system, which is applicable to a virtual application server and includes: performing an interaction with a virtual application client of a terminal device and launching an application according to the interaction; and obtaining and opening a file managed by the online working system based on browser/server architecture in the application, and sending an interface in which the file is opened to the terminal device, wherein the online working system is deployed on an online working system server, and the obtaining the file comprises: transmitting the file from a first storage device related to the online working system server to a second storage device related to the virtual application server.

At least some embodiments of the present disclosure further provides a file processing method based on an online working system, which is applicable to a virtual application server and includes: performing an interaction with a virtual application client of a terminal device and sending an interface of an application for editing a file to the terminal device; transmitting the file to a second storage device related to the virtual application server in response to an operation of a user synchronizing the file to the online working system based on browser/server architecture in the application, wherein the online working system is deployed on an online working system server; and transmitting the file from the second storage device to a first storage device related to the online working system server.

At least some embodiments of the present disclosure further provides a storage medium, which includes a program stored thereon. Upon the program being run by a processor, the method according to any one of the above embodiments is executed by the processor.

At least some embodiments of the present disclosure further provides a file processing apparatus based on an online working system, which includes: a first interacting module, configured to perform an interaction with a virtual application client of a terminal device and to launch an application according to the interaction; a file opening module, configured to open a file managed by the online working system based on browser/server architecture in the application, and to send an interface in which the file is opened to the terminal device, wherein the online working system is deployed on an online working system server; and a first file transmitting module, configured to transmit the file from a first storage device related to the online working system server to a second storage device related to the virtual application server.

At least some embodiments of the present disclosure further provides a file processing apparatus based on an online working system, which includes: a second interacting module, configured to perform an interaction with a virtual application client of a terminal device and to send an interface of an application for editing a file to the terminal device; a second file transmitting module, configured to transmit the file to a second storage device related to the virtual application server in response to an operation of a user synchronizing the file to the online working system based on browser/server architecture in the application, wherein the online working system is deployed on an online working system server; and a file storing module, configured to transmit the file from the second storage device to a first storage device related to the online working system server.

At least some embodiments of the present disclosure further provides a file processing apparatus based on an online working system, which includes: a first processor; and a first memory, coupled with the first processor, and configured to provide the first processor with an instruction for executing steps as follows: performing an interaction with a virtual application client of a terminal device and launching an application according to the interaction; and obtaining and opening a file managed by the online working system based on browser/server architecture in the application, and sending an interface in which the file is opened to the terminal device, wherein the online working system is deployed on an online working system server, and the obtaining the file comprises: transmitting the file from a first storage device related to the online working system server to a second storage device related to the virtual application server.

At least some embodiments of the present disclosure further provides a file processing apparatus based on an online working system, which includes: a second processor; and a second memory, coupled with the second processor, and configured to provide the second processor with an instruction for executing steps as follows: performing an interaction with a virtual application client of a terminal device and sending an interface of an application for editing a file to the terminal device; transmitting the file to a second storage device related to the virtual application server in response to an operation of a user synchronizing the file to the online working system based on browser/server architecture in the application, wherein the online working system is deployed on an online working system server; and transmitting the file from the second storage device to a first storage device related to the online working system server.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIGS. 1A-1C are schematic diagrams of three online working systems;

FIG. 2 is a block diagram of a hardware structure of a computing device for implementing a file processing method based on an online working system provided by the embodiments of the present disclosure;

FIG. 3 is a schematic diagram of a file processing system based on an online working system provided by some embodiments of the present disclosure;

FIG. 4 is a schematic diagram of an architecture of a file processing system based on an online working system provided by some embodiments of the present disclosure;

FIG. 5 is a flowchart of a file processing method based on an online working system provided by some embodiments of the present disclosure;

FIG. 6 is a flowchart of another file processing method based on the online working system provided by some embodiments of the present disclosure;

FIG. 7A is a flowchart of an operation process provided by some embodiments of the present disclosure;

FIG. 7B is a flowchart of another operation process provided by some embodiments of the present disclosure;

FIG. 7C is a flowchart of further another operation process provided by some embodiments of the present disclosure;

FIG. 8 is a schematic diagram of a file processing apparatus based on an online working system provided by some embodiments of the present disclosure;

FIG. 9 is a schematic diagram of another file processing apparatus based on an online working system provided by some embodiments of the present disclosure;

FIG. 10 is a schematic diagram of a file processing apparatus based on an online working system provided by some embodiments of the present disclosure; and

FIG. 11 is a schematic diagram of another file processing apparatus based on an online working system provided by some embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

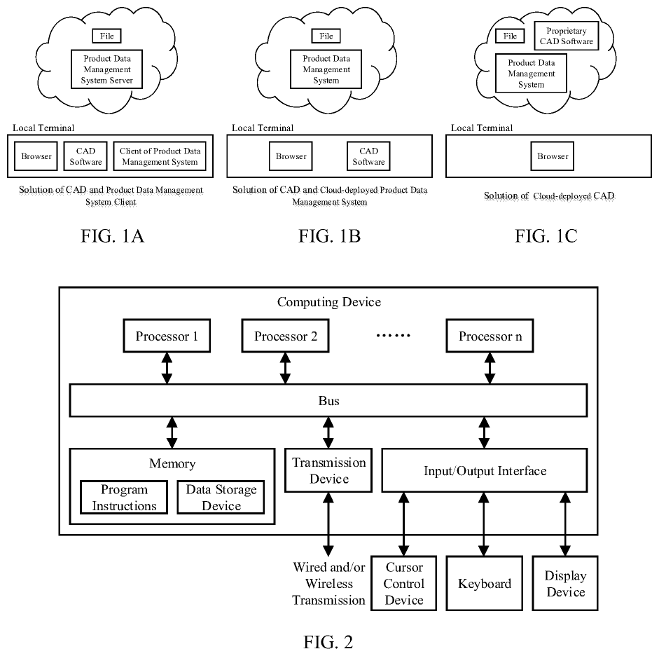

FIGS. 1A-1C illustratively show three data management system solutions. Referring to FIG. 1A, installing CAD software and a client of a product data management system on a local terminal is a mainstream solution on the market at present. It is necessary to install the CAD software and the client of the product data management system on a local computer, which has high requirements on the configuration of the local computer, and is complex in the software program installation process; and every user usually occupies a set of software and hardware resources, resulting in high cost. FIG. 1B shows a technical solution of deploying CAD software on a local terminal and deploying the product data management system in a cloud. Compared with the solution shown in FIG. 1A, the solution shown in FIG. 1B is greatly improved. The product data management system is completely deployed in the cloud, but a local computer is still needed to install the CAD software. FIG. 1C shows a solution of deploying both CAD software and the product data management system in the cloud. However, the CAD software deployed in the cloud on the market has quite different functions and interactive experience from the client CAD software deployed on a local terminal. The function of the product data management system matched with the cloud CAD is weak, which may not meet the integration requirements of different users on other CAD software, so that applications may not be utilized reasonably to process files.

The online working systems described above have the problem that the programs may not be utilized reasonably to process the files and the online working efficiency is influenced.

At least some embodiments of the present disclosure provide a file processing method based on an online working system. The method is applicable to a virtual application server. The method includes: performing, via the virtual application server, an interaction with a virtual application client of a terminal device and launching an application according to the interaction; obtaining and opening, via the virtual application server, a file managed by the online working system based on browser/server architecture in the application, and sending an interface in which the file is opened to the terminal device; wherein the online working system is deployed on an online working system server; and the obtaining the file via the virtual application server includes: transmitting, via the virtual application server, the file from a first storage device related to the online working system server to a second storage device related to the virtual application server.

Some embodiments of the present disclosure further provide an apparatus and a storage medium corresponding to the file processing method described above.

In the file processing method based on the online working system provided by the embodiment of the present disclosure, the virtual application server firstly performs an interaction with the virtual application client of the terminal device, and launches the application according to the interaction; then the virtual application server obtains and opens the file managed by the online working system based on browser/server (B/S) architecture in the application, and sends the interface in which the file is opened to the terminal device. The online working system is deployed on the online working system server. The virtual application server can transmit the file from the first storage device related to the online working system server to the second storage device related to the virtual application server, so as to realize obtaining the file. Compared with the solutions of the three online working systems shown in FIGS. 1A-1C, firstly, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. The present solution can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the present solution can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

Some embodiments of the present disclosure and examples thereof are described in detail below with reference to the accompanying drawings. It should be understood that the specific embodiments described herein are merely used to illustrate and explain the present disclosure, and are not limitative to the present disclosure.

At least some embodiments of the present disclosure provide a file processing method based on an online working system. It should be noted that steps shown in a flowchart among the accompanying drawings can be executed in a computer system including, for example, a set of computer executable instructions. Moreover, although a logic order is shown in the flowchart, the steps shown or described here can be executed in an order different from that shown in the flowchart in some cases.

The file processing method based on the online working system provided by the embodiment of the present disclosure can be executed in a mobile terminal, a computer terminal, a server or a similar computing device. FIG. 2 is a block diagram of a hardware structure of a computing device for implementing the file processing method based on the online working system. As shown in FIG. 2, the computing device can include one or more processors (the processor can include but is not limited to a processing element, such as a micro processing unit (MCU) or a field programmable gate array (FPGA), etc.), a memory for storing data, and a transmission device for a communication function. In addition, the computing device can further include a display device, an input/output interface (I/O interface), a universal serial bus (USB) port (which can be one of ports of the I/O interfaces), a network interface, a power source and/or a camera. Those skilled in the art can understand that the structure shown in FIG. 2 is merely illustrative, and does is not limitative to the structure of the computing device. For example, the computing device can also include more or fewer components than those shown in FIG. 2, or can have different configurations from that shown in FIG. 2.

It should be noted that the one or more processors and/or other data processing circuits described above can be generally referred to as “data processing circuits” in the present disclosure. The data processing circuit can be fully or partially embodied as software, hardware, firmware or any other combinations thereof. In addition, the data processing circuit can be an independent processing module, and be combined fully or partially into any one of the other components in the computing device. As mentioned in the embodiments of the present disclosure, the data processing circuit is used as a processor for control (for example, selecting of variable resistance terminal routes coupled with an interface).

The memory can be used to store software programs and modules of an application software, such as the program instructions/data storage device corresponding to the file processing method based on the online working system in the embodiment of the present disclosure. The processor runs the software programs and modules stored in the memory so as to execute various function applications and data processing, for example, to implement the file processing method based on the online working system. The memory can include a high-speed random access memory, and can also include a non-volatile memory, such as one or more magnetic storage devices, a flash memory or any other non-volatile solid memories. In some embodiments, the memory can further include a storage device that is arranged remotely relative to the processor. The remote storage device can be coupled to the computing device through a network. The implements of the network can include but are not limited to Internet, corporate intranet, local area networks, mobile communication networks and any combinations thereof.

The transmission device is used to receive or send data via a network. A specific embodiment of the above network can include a wireless network provided by a communication provider of the computing device. In an embodiment, the transmission device includes a network interface controller (NIC), which may be coupled with other network devices through a base station, so that the transmission device can be communicated with the Internet. In an embodiment, the transmission device can be a radio frequency (RF) module, which is used to communicate with the Internet in a wireless way.

The display device can be, for example, a touch-screen liquid crystal display device (LCD). The liquid crystal display device can enable the user to interact with a user interface of the computing device.

In addition, it should be noted that in some optional embodiments, the computing device shown in FIG. 2 can include hardware elements (including circuits), software elements (including computer codes stored on a computer readable medium), or a combination of the hardware elements and the software elements. It should be pointed out that FIG. 2 is merely an example of a specific embodiment and intends to illustrate the types of components that may exist in the computing device.

FIG. 3 is a schematic diagram of a file processing system based on an online working system provided by some embodiments of the present disclosure. Referring to FIG. 3, the file processing system based on the online working system includes a terminal device 100, an online working system server 200 and a virtual application server 300. The online working system can be, for example, an online working system based on browser/server (B/S) architecture. The online working system is deployed on the online working system server. The online working system server 200 can provide a work page for a user 10. The user 10 can utilize a browser of the terminal device 100 to access the work page, so that the online working system provides a service of file management and product data management for the user 10, and further, the online working system server 200 can provide a collaborative research and development design environment for the user 10. The terminal device 100 can be, for example, a smart phone, a tablet computer, a personal computer or any other terminal device. The browser can be, for example, any browser that exists at present or may appear in the future, which is not specifically limited here. In practical online working, the user 10 can access the work page of the online working system set on the online working system server 200 via the browser of the terminal device 100 and can perform a trigger operation on the work page. The virtual application server 300 is provided with applications that are needed in the work for the user. Therefore, the online working system server 200 can call a virtual application client of the terminal device 100, and then the terminal device 100 can receive an interface of the application related to the trigger operation from the virtual application server 300 via the virtual application client and display the interface of the application on the virtual application client. Further, the user 10 can utilize the application to work in the virtual application client. It should be noted that the hardware structure described above is applicable to the online working system server 200, the virtual application server 300 and the terminal device 100 in the system.

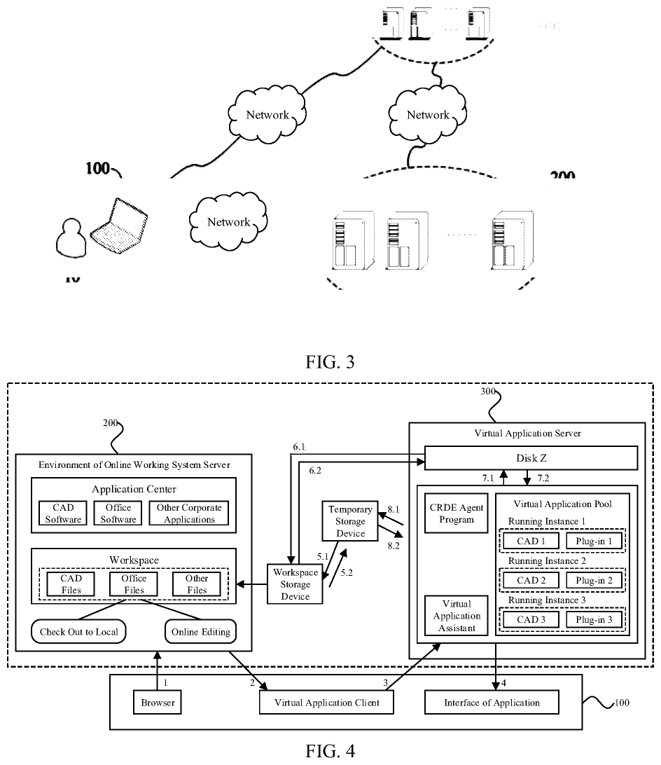

Further, FIG. 4 is a schematic diagram of an architecture of a file processing system based on an online working system provided by some embodiments of the present disclosure. Referring to FIG. 4, the online working system set on the online working system server 200 includes an application center and a workspace. The application center provides the user 10 with the service of launching the applications, such as CAD software, Office software and other corporate applications. The workspace provides the user 10 with the service of file management. The online working system server 200 is also related to a workspace storage device which is used to store files, such as Office files, CAD files, etc., managed by the online working system. In addition, referring to FIG. 4, the virtual application server 300 is provided with a virtual application system. The virtual application system is provided with: a virtual application assistant module (i.e. a virtual application assistant) interacting with the virtual application client on the terminal device 100; an agent module (for example, corresponding to a CRDE agent in FIG. 4) for accessing the workspace storage device related to the online working system server 200; and an application. In addition, the virtual application server 300 is also related to a virtual cloud disk (corresponding to the disk Z in FIG. 4) and a temporary storage device (such as a cache device).

Moreover, referring to FIG. 4, the user 10 can firstly log in to the online working system on the online working system server 200 via the browser; then the online working system server 200 interacts with the terminal device 100 to call the virtual application client of the terminal device 100; then the terminal device 100 interacts with the virtual application server 300, and displays an interface of the application provided by the virtual application server 300 on the virtual application client. Therefore, the user 10 can perform editing or designing work in the interface of the application provided by the virtual application server 300 to the terminal device 100. In addition, the virtual application server 300 can also interact with the online working system server 200 to read and store the file.

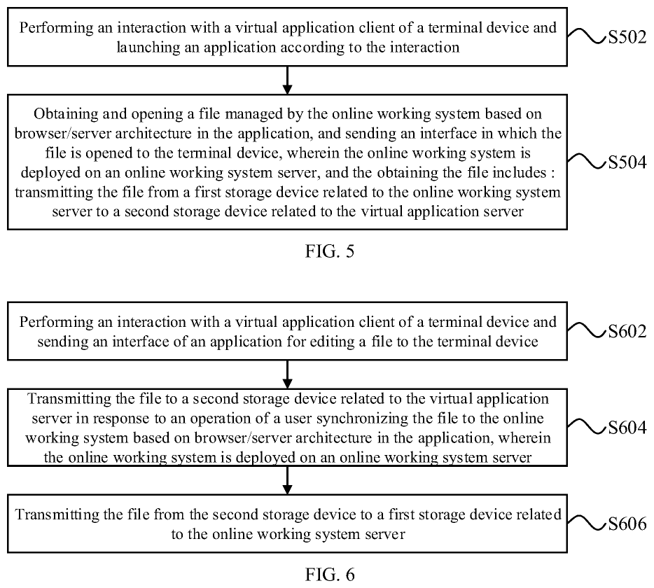

Based on the above running environment, some embodiments of the present disclosure provide a file processing method based on an online working system. The method is, for example, implemented by the virtual application server 300 as shown in FIG. 3. FIG. 5 is a flowchart of the method. Referring to FIG. 5, the method includes:

S502: performing an interaction with a virtual application client of a terminal device and launching an application according to the interaction; and

S504: obtaining and opening a file managed by the online working system based on browser/server architecture in the application, and sending an interface in which the file is opened to the terminal device, wherein the online working system is deployed on an online working system server, and the obtaining the file includes: transmitting the file from a first storage device related to the online working system server to a second storage device related to the virtual application serve.

As described above, in the R&D process of complex industrial products, the R&D team organized across enterprises and regions must cooperate with one another to conduct the research and development after solving technical problems and confirming the follow-up work. However, the aforementioned three online working systems have the problem that the applications may not be utilized reasonably to process files and the online working efficiency in influenced.

In terms of the above problem, in the file processing method provided by the present embodiment, in step S502, the virtual application server 300 firstly performs an interaction with the virtual application client of the terminal device, and launches the application according to the interaction. In practical application, in the case where the user 10 needs to use the online working system to work, the user 10 can input an account in the browser of the terminal device 100 to log in to the online working system, and in the case where the account passes the verification, the browser of the terminal device 100 can display a work page sent by the remote online working system server 200. The content displayed in the work page can refer to the content provided by the application center and the workspace shown in FIG. 4. The content displayed in the work page at least includes an application identifier (such as a program icon) of the application that can be called by the system and a file identifier of the file that is managed by the system. Further, after the browser displays the work page, the user 10 can perform a trigger operation on the work page, and the trigger operation is related to the application needed to process the file. For example, the trigger operation can be that the user 10 clicks on the application identifier of the application, or clicks on the file identifier of the file edited by the application. In this case, the terminal device 100 cam interact with the online working system server 200 in response to the trigger operation of the user 10 on the work page. Then, in the interaction process between the terminal device 100 and the online working system server 200, the online working system server 200 can, for example, send interaction information to the terminal device 100. Then, the terminal device 100 can call the virtual application client according to the interaction information. The virtual application client can be, for example, pre-installed on the terminal device 100, or can be downloaded by the terminal device 100 according to the interaction information. The virtual application client is not specifically limited here. In the case where the terminal device 100 calls the virtual application client, the virtual application server 300 can interact with the virtual application client of the terminal device 100, and then launches the application, such as the CAD application or the Office program, according to the interaction.

Further, in step S504, the virtual application server 300 obtains and opens the file managed by the online working system based on B/S architecture in the application, and sends the interface in which the file is opened to the terminal device. That is, the virtual application server 300 can utilize the launched application to open the file managed by the online working system, and for example, the virtual application server 300 utilizes a launched CAD application to open a CAD file managed by the online working system, or the virtual application server 300 utilizes a launched Office program to open an Office file managed by the online working system. Then, the virtual application server 300 sends the interface of the application in which the file is opened to the terminal device 100. Specifically, for example, the interface of the application in which the file is opened is sent to the virtual application client launched by the terminal device 100, so that the virtual application client can display the interface of the application in which the file is opened, and further, the user can perform an operation on the file on the virtual application client, so as to realize the purpose of online working.

Before the virtual application server 300 opens the file managed by the online working system based on B/S architecture in the application, the virtual application server 300 needs to obtain the file managed by the online working system. As described above, the online working system server 200 is related to a workspace storage device, and the virtual application server 300 is related to a disk Z (i.e. virtual cloud disk) and a temporary storage device. In the operation that the virtual application server 300 obtains the file, the virtual application server 300 can transmit the file from a first storage device (corresponding to the workspace storage device in FIG. 4) related to the online working system server 200 to a second storage device related to the virtual application server 300, wherein the second storage device can be the disk Z (the virtual cloud disk) or the temporary storage device. Accordingly, the virtual application server 300 can open the file in the second storage device related to the virtual application server 300.

Thus, in this way, the virtual application server firstly performs an interaction with the virtual application client of the terminal device, and launches the application according to the interaction; then the virtual application server obtains and opens the file managed by the online working system based on browser/server (B/S) architecture in the application, and sends the interface in which the file is opened to the terminal device. The virtual application server can transmit the file from the first storage device related to the online working system server to the second storage device related to the virtual application server, so as to realize obtaining the file. Compared with the solutions of the three online working systems shown in FIGS. 1A-1C, firstly, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. Compared with the solutions of the three online working systems shown in FIGS. 1A-1C, the technical solution of the present embodiment can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the technical solution of the present embodiment can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

For example, the operation that the virtual application server performs the interaction with the virtual application client of the terminal device and launches the application according to the interaction, includes: the virtual application server receives an application launch command for launching the application from the virtual application client via a first agent module; and the virtual application server launches the application via the first agent module in response to the application launch command.

For example, as described above, the user 10 can perform a trigger operation on the work page, and then the terminal device 100 can interact with the online working system server 200. In the interaction process, the terminal device 100 firstly sends trigger information related to the trigger operation to the online working system server 200 in response to the trigger operation of the user on the work page, and the trigger information indicates a target object to which the trigger operation is applied. In a specific embodiment, for example, the user 10 can perform a click operation on the application identifier of the application in the work page (that is, the target object to which the trigger operation is applied is an application identifier), or the user 10 can perform a click operation on the file identifier (that is, the target object to which the trigger operation is applied is a file identifier). In this case, the terminal device 100 can send the trigger information to the online working system server 200, and the trigger information, for example, indicates that the user 10 performs a trigger operation on the application identifier or the file identifier on the work page. Further, after receiving the trigger information, the online working system server 200 can send to the terminal device 100 the application launch command according to the trigger information and target information corresponding to the trigger information. The target information is used to indicate the target object to be launched by the virtual application server 300. For example, the application is launched or the file is launched, and launching the file can also trigger the launching of the application. For example, in the case where the user triggers the application identifier on the work page, the target information is the information of the application corresponding to the application identifier; and in the case where the user triggers the file identifier of the file on the work page, the target information is the file information corresponding to the file identifier. Therefore, in the case where the application or the file is launched, the application can be triggered to start. Further, the virtual application server 100 can interact with the virtual application client of the terminal device 100. In the interaction process, the terminal device 100 can send the application launch command for launching the application, such as the launch command for launching the CAD application, to the virtual application server 300 via the virtual application client.

In this case, the virtual application server 300 can receive the application launch command for launching the application. More specifically, the virtual application server 300 can receive the application launch command from the virtual application client via a first agent module. The first agent module can, for example, correspond to the virtual application assistant in FIG. 4, and the virtual application assistant can schedule, for example, various functions of the virtual application server. Further, the virtual application server 300 launches the application via the first agent module (i.e. the virtual application assistant) in response to the application launch command.

Therefore, the online working system server 200 cam determine which target object is triggered by the user, and then determine the application to be launched. Further, the terminal device 100 sends the application launch command to the virtual application server, and finally the virtual application server 300 can launces the application via an agent module according to the command.

For example, the operation that the virtual application server transmits the file from the first storage device related to the online working system server to the second storage device related to the virtual application server, includes: the virtual application server receives file information of the file from the virtual application client via the first agent module; and the virtual application server invokes a second agent module via the first agent module to control the first storage device to transmit the file to the second storage device, wherein the second agent module is configured to schedule the first storage device and the second storage device.

Specifically, in the operation that the virtual application server transmits the file from the first storage device related to the online working system server to the second storage device related to the virtual application server, the virtual application server 300 can receive the file information of the file from the virtual application client via the first agent module. In practical application, in the case where the user 10 triggers the file identifier of the file on the work page, the target information sent by the online working system server 200 to the terminal device 100 is the file information. Then, the terminal device 100 can send the file information to the virtual application server 300 via the virtual application client. In this case, the virtual application server 300 can receive the file information of the file from the virtual application client via the first agent module. Further, the virtual application server 300 invokes the second agent module via the first agent module to control the first storage device (corresponding to the workspace storage device in FIG. 4) to transmit the file to the second storage device (corresponding to the disk Z or the temporary storage device in FIG. 4). The second agent module can correspond to the CRDE agent in FIG. 4. The second agent module is, for example, in charge of controlling the first storage device to transmit the file to the second storage device, and the second agent module (the CRDE agent) is invoked by the first agent module (the virtual application assistant). Therefore, in this way, the virtual application server can obtain the file according to the file information.

For example, the operation that the virtual application server transmits the file from the first storage device related to the online working system server to the second storage device related to the virtual application server, includes: the virtual application server controls the first storage device via a second agent module to transmit the file to the second storage device, wherein the second agent module is configured to schedule the first storage device and the second storage device.

Specifically, referring to the above description, the second agent module (e.g., the CRDE agent) set on the virtual application server is configured to schedule the first storage device (e.g., the workspace storage device) and the second storage device (e.g., the temporary storage device). Therefore, in the operation that the virtual application server transmits the file from the first storage device related to the online working system server to the second storage device related to the virtual application server, the virtual application server 300 cam control the first storage device via the second agent module (i.e., the CRDE agent) to transmit the file to the second storage device, wherein the second agent module is configured to schedule the first storage device and the second storage device, that is, the second agent module is configured to control the first storage device to transmit the file to the second storage device.

For example, the method further includes: causing the online working system server to send an application launch request for launching the application and file information of the file to the virtual application client of the terminal device in response to a trigger operation of a user on a file identifier of the file on a work page of the online working system; wherein the file is a file of a specified type, and the operation that the virtual application server interacts with the virtual application client of the terminal device and launches the application according to the interaction includes: the virtual application server receives an application launch command corresponding to the application launch request from the virtual application client and launches the application according to the application launch command. The operation that the virtual application server transmits the file from the first storage device related to the online working system server to the second storage device related to the virtual application server includes: the virtual application server transmits the file from the first storage device related to the online working system server to the second storage device related to the virtual application server, wherein the second storage device is configured to store the file of the specified type.

Specifically, in practical application, the user 10 can trigger the file identifier of the file on the work page of the online working system, the triggered file can be a file of a specified type, and the file of the specified type is, for example, a CAD file. In this case, the online working system server 200 sends to the virtual application client of the terminal device 100 a launch request for launching the application (i.e., launching the CAD application) in response to the trigger operation of the user on the file identifier of the file of the specified type on the work page of the online working system. Further, the terminal device 100 can send an application launch command corresponding to the application launch request to the virtual application server 300 via the virtual application client. In this case, the virtual application server 300 receives the application launch command from the virtual application client and launches the application (i.e., the CAD application) according to the application launch command. Moreover, in the case where the user 10 triggers the file identifier of a CAD file, in the operation that the virtual application server transmits the file from the first storage device (i.e., the workspace storage device) related to the online working system server to the second storage device (i.e., the temporary storage device) related to the virtual application server, the virtual application server 300 can transmit the file (i.e., the CAD file) from the first storage device related to the online working system server 200 to the second storage device related to the virtual application server. The second storage device here corresponds to the temporary storage device in FIG. 4, and the temporary storage device is mainly configured to store the file of the specified type such as the CAD file.

For example, the operation that the virtual application server opens the file includes: the virtual application server loads the file from the second storage device to the application in response to an operation of the user triggering a plug-in set in the application, wherein the plug-in is configured to check out the file.

Specifically, in terms of the file of the specified type such as the CAD file, etc., a plug-in can be preset in the application (such as the CAD application) corresponding to the file of the specified type, and a button corresponding to the plug-in can be set in an operation interface of the CAD application. The CAD file may be checked out from the second storage device (corresponding to the temporary storage device) via the plug-in and loaded to the CAD application. In practical operation, the user 10 can trigger the plug-in in the CAD application, and for example, the user 10 can click on a “check-out” button corresponding to the plug-in in the interface of the CAD application. In this case, the virtual application server 300 can send a prompt page to the terminal device 100. The content displayed in the prompt page can be, for example, a BOM structure of the CAD files stored in the second storage device. Therefore, the user 10 can select a CAD file to be opened by the CAD application according to the prompt page. In this case, in the operation that the virtual application server opens the file, the virtual application server 300 can load the file from the second storage device to the application in response to the operation of the user triggering the plug-in set in the application (the CAD application). Therefore, the CAD file can be checked out directly from the second storage device and loaded into the CAD application via the preset plug-in.

For example, the method further includes: causing the online working system server to send an application launch request for launching the application and file information of the file to the virtual application client of the terminal device in response to a trigger operation of a user on a file identifier of the file on a work page of the online working system; wherein the file is a file of an unspecified type, and the operation that the virtual application server interacts with the virtual application client of the terminal device and launches the application according to the interaction includes: the virtual application server receives an application launch command corresponding to the application launch request from the virtual application client, and launches the application according to the application launch command. The operation that the virtual application server transmits the file from the first storage device related to the online working system server to the second storage device related to the virtual application server includes: the virtual application server receives a file start instruction corresponding to the file information from the virtual application client, wherein the file start instruction is used to instruct the virtual application server to open the file; and the virtual application server transmits the file from the first storage device related to the online working system server to the second storage device related to the virtual application server in response to the file start instruction, wherein the second storage device is configured to store the file of the unspecified type.

Specifically, the user 10 can also trigger the file identifier of a file of an unspecified type on the work page, and the file of the unspecified type can be, for example, an Office file. In this case, the online working system server 200 sends to the virtual application client of the terminal device 100 the application launch request for launching the application (e.g., launching the Office program) and the file information of the file in response to the trigger operation of the user on the file identifier of the file of the unspecified type on the work page of the online working system. Further, the terminal device 100 can send an application launch command corresponding to the application launch request to the virtual application server 300 via the virtual application client. In this case, the virtual application server 300 receives the application launch command from the virtual application client and launches the application (i.e., the Office program) according to the application launch command. In addition, the content that is sent by the terminal device 100 to the virtual application server 300 via the virtual application client can further include the file start instruction corresponding to the file information. The file start instruction can instruct the virtual application server 300 to open the file. Therefore, in the operation that the virtual application server 300 transmits the file from the first storage device related to the online working system server 200 to the second storage device related to the virtual application server, the virtual application server 300 can also receive the file start instruction from the virtual application client and then transmits the file of the unspecified type (such as the Office file) to be opened from the first storage device related to the online working system server 200 to the second storage device related to the virtual application server in response to the file start instruction. The second storage device here corresponds to the disk Z (the virtual cloud disk) in FIG. 4 and is configured to store the file of the unspecified type such as the Office file.

For example, the operation that the virtual application server opens the file includes: the virtual application server loads the file from the second storage device to the application after launching the application. Specifically, in the case where the file to be opened is the file of the unspecified type, in the operation that the virtual application server opens the file, the virtual application server 300 can load the file directly from the second storage device to the application after launching the application, without depending on the check-out operation of the user (e.g., triggering a control for checking out the file). In a specific embodiment, after the virtual application server 300 launches the Office application, the virtual application server 300 can obtain the Office file directly from the second storage device (corresponding to the disk Z) and loads the Office file directly with the Office program.

Therefore, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. Compared with the solutions of the three online working systems shown in FIGS. 1A-1C, the technical solution of the present embodiment can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the technical solution of the present embodiment can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

Some embodiments of the present disclosure further provide another file processing method based on an online working system. The method is, for example, implemented by the virtual application server 300 as shown in FIG. 3. FIG. 6 is a flowchart of the method. Referring to FIG. 6, the method includes:

S602: performing an interaction with a virtual application client of a terminal device and sending an interface of an application for editing a file to the terminal device;

S604: transmitting the file to a second storage device related to the virtual application server in response to an operation of a user synchronizing the file to the online working system based on browser/server architecture in the application, wherein the online working system is deployed on an online working system server; and

S606: transmitting the file from the second storage device to a first storage device related to the online working system server.

For example, in the file processing method provided by the present embodiment, in step S602, the virtual application server 300 interacts with the virtual application client of the terminal device 100 and sends the interface of the application for editing the file to the terminal device 100. Therefore, the virtual application client of the terminal device 100 can display the interface of the application for editing the file, so that the user 10 can edit the file in the application.

Further, in step S604, after the user 10 finishes editing the file, the user 10 can perform an operation (such as save or save-as operation) of synchronizing the edited file to the online working system based on B/S architecture in the interface of the application. In this case, the virtual application server 300 transmits the file to the second storage device related to the virtual application server, such as the disk Z or the temporary storage device in FIG. 4, in response to the operation of the user synchronizing the file to the online working system based on B/S architecture in the application.

Finally, the virtual application server 300 transmits the file from the second storage device to the first storage device related to the online working system server, that is, the file in the second storage device is stored into, for example, the workspace storage device, thereby finishing the storage work of the online file.

Therefore, in this way, the virtual application server sends the interface of the application for editing the file to the terminal device, and after the file is edited, the virtual application server transmits the file to the second storage device related to the virtual application server in response to the operation of the user synchronizing the file to the online working system based on B/S architecture in the application, and finally the virtual application server transmits the file from the second storage device to the first storage device related to the online working system server, thus finishing file storage of online working. And the technical problems of the three online working systems as shown in FIGS. 1A-1C that the application may not be utilized reasonably to process the file and the online working efficiency is influenced, are solved.

For example, the operation that the virtual application server transmits the file from the second storage device to the first storage device related to the online working system server includes: the virtual application server transmits the file from the second storage device to the first storage device via a second agent module. The second agent module is configured to schedule the first storage device and the second storage device. Specifically, in the operation that the virtual application server transmits the file from the second storage device to the first storage device related to the online working system server, the virtual application server 300 can transmit the file from the second storage device to the first storage device via the second agent module (corresponding to the CRDE agent in FIG. 4), and the second agent module is configured to schedule the first storage device and the second storage device.

For example, the file is a file of an unspecified type, and the virtual application server saves the file to the second storage device configured for storing the file of the unspecified type in response to an operation of the user utilizing a storage function of the application to save the file. Specifically, the file edited by the user 10 is the file of the unspecified type, such as an Office file. After editing the Office file, the user 10 can perform the save or save-as operation in the Office application. In this case, the virtual application server 300 can save the file to the second storage device configured for storing the file of the unspecified type in response to the operation of the user utilizing the storage function of the application to save the file. The second storage device here corresponds to the disk Z (the virtual cloud disk) in FIG. 4, and the second storage device is mainly configured to store the file of the unspecified type.

For example, the file is a file of a specified type, and the virtual application server saves the file to the second storage device configured for storing the file of the specified type via the application in response to an operation of the user clicking on a plug-in set in the application, wherein the plug-in is configured to check in the file to the online working system.

Specifically, the file edited by the user 10 can also be the file of the specified type, such as a CAD file. In terms of the file of the specified type, the plug-in can be preset in the application (e.g., the CAD application) that opens the file of the specified type, a button corresponding to the plug-in can be set in an operation interface of the CAD application, and the saved file can be checked in to the online working system via the plug-in. After the user finishes editing the CAD file, the user can click on a “check-in” button (related to the plug-in) in the interface of the CAD application. In this case, the virtual application server 300 can send a prompt page to the terminal device 100. The content displayed in the prompt page can be, for example, a BOM structure of the CAD files managed by the online working system. Therefore, the user 10 can edit the attribute of the CAD file to be saved, i.e., determine the structure of the CAD file in the BOM according to the prompt page. In this case, the virtual application server 300 saves the file to the second storage device configured for storing the file of the specified type via the application in response to the operation of the user clicking on the plug-in set in the application. The second storage device here corresponds to the temporary storage device in FIG. 4, and the temporary storage device is mainly configured to store the file of the specified type such as the CAD file, etc.

For example, in the case of defecting that the file in the second storage device is updated, the virtual application server transmits the file from the second storage device to the first storage device via the second agent module. Specifically, the case where the virtual application server 300 detects that the file in the second storage device is updated, can be a case where the second agent module of the virtual application server 300 detects that the file in the second storage device is updated. For example, in the case where the file in the disk Z is updated and/or the file in the temporary storage device is updated, the virtual application server 300 transmits the file from the second storage device to the first storage device (the workspace storage device) via the second agent module (the CRDE agent).

In addition, in the present embodiment, the online working system server 200 can also update data information related to the saved file according to the save operation performed on the edited file. In practical operation, after the edited file is saved, the file information of a storage space related to the online working system server 200 may change. In this case, the online working system server 200 needs to update the data information related to the saved file and also needs to change the file identifier on the work page. Therefore, the synchronization of data is ensured.

In addition, it should be added that in one specific embodiment, the user 10 can trigger the application identifier of the application (such as an icon of the application) on the work page. In this case, the trigger information generated by the terminal device 100 via the browser corresponds to the identifier information of the application identifier, and for example, the identifier information can be the identifier information of the CAD application or the identifier information of any other application software. Then the terminal device 100 sends the identifier information to the online working system server 200 via the browser. In response to the identifier information, the application center of the online working system server 200 generates target information corresponding to the identifier information. In this case, the target information generated by the online working system server 200 is the application information of the application, i.e., the information of the CAD application. Then the online working system of the online working system server 200 sends the target information (i.e. the information of the CAD application) to the terminal device 100. Therefore, the virtual application client of the terminal device 100 generates a target launch command according to the target information. The target launch command generated by the virtual application client is a launch command for launching the CAD application. The virtual application client sends the launch command to the virtual application server 300, so that the virtual application server 300 can launch the CAD application according to the launch command. Therefore, in this way, the user can trigger the identifier of the application on the work page of the online working system to call the application, so that the user can simply and quickly utilize the application in the collaborative working process. In addition, the user 10 can trigger the file identifier on the work page. For example, the user 10 can click on the CAD file edited by CAD on the work page. In this case, the trigger information generated by the terminal device 100 via the browser is the identifier information of the file identifier, and for example, the identifier information is the file identifier information of the CAD file. Then the terminal device 100 sends the identifier information to the online working system server 200 via the browser. The workspace of the online working system server 200 generates target information corresponding to the identifier information in response to the identifier information. In this case, the target information generated by the online working system server 200 is the file information of the CAD file. Then the online working system of the online working system server 200 sends the file information of the CAD file to the terminal device 100. Therefore, the virtual application client of the terminal device 100 generates a target start instruction according to the information. The target start instruction generated by the virtual application client is a start instruction for starting the CAD file. The virtual application client sends the start instruction to the virtual application server 300, so that the virtual application server 300 can launch the CAD application and starts the CAD file in the CAD application according to the start instruction. Therefore, the user can trigger the identifier of the file on the work page of the online working system to call a relevant application, so that the user can simply and quickly utilize the application to open the work file in the collaborative working process.

Therefore, in the present embodiment, the virtual application server sends the interface of the application for editing the file to the terminal device, and after the file is edited, the virtual application server transmits the file to the second storage device related to the virtual application server in response to the operation of the user synchronizing the file to the online working system based on B/S architecture in the application, and finally the virtual application server transmits the file from the second storage device to the first storage device related to the online working system server, thus finishing file storage of online working. And the technical problems of the three online working systems as shown in FIGS. 1A-1C that the application may not be utilized reasonably to process the file and the online working efficiency is influenced, are solved.

In addition, referring to FIG. 2, some embodiments of the present disclosure further provide a storage medium (e.g., the memory shown in FIG. 2). The storage medium includes programs stored thereon, wherein upon the program being run by a processor, the method provided by any one of the above embodiments is executed by the processor.

Therefore, according to the present embodiment, the virtual application server firstly performs an interaction with the virtual application client of the terminal device, and launches the application according to the interaction; then the virtual application server obtains and opens the file managed by the online working system based on browser/server (B/S) architecture in the application, and sends the interface in which the file is opened to the terminal device. The virtual application server can transmit the file from the first storage device related to the online working system server to the second storage device related to the virtual application server, so as to realize obtaining the file. Compared with the solutions of the three online working systems shown in FIGS. 1A-1C, firstly, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. Compared with the solutions of the three online working systems shown in FIGS. 1A-1C, the technical solution of the present embodiment can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the technical solution of the present embodiment can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

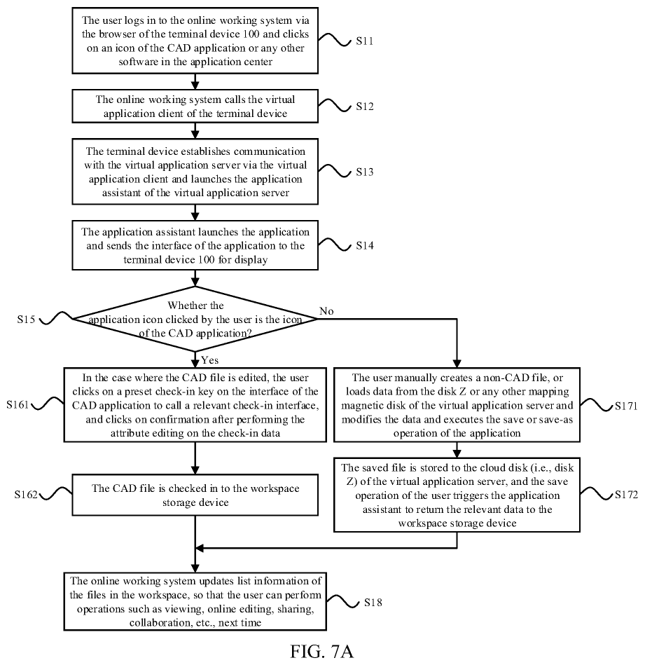

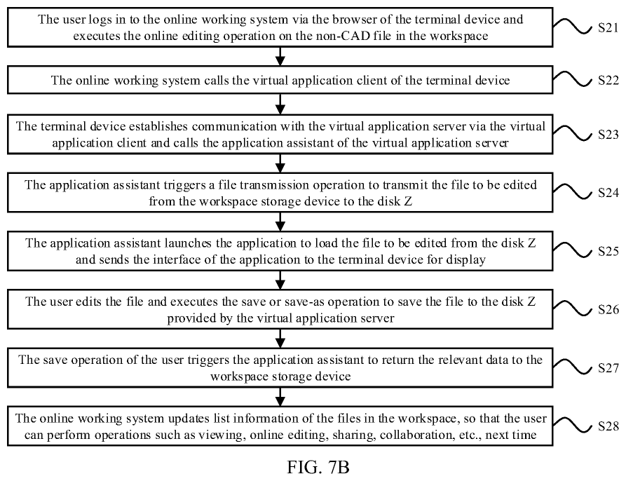

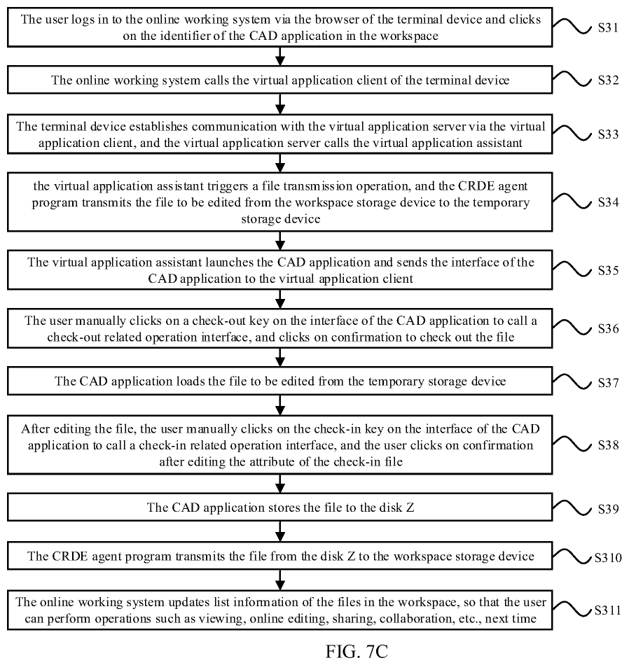

It should also be added that referring to FIG. 4 and FIG. 7A, the application center of the online working system launches the CAD application or other software deployed on the virtual application server in the following steps:

S11: the user logs in to the online working system via the browser of the terminal device 100 and clicks on an icon of the CAD application or any other software in the application center (corresponding to step 1 in FIG. 4);

S12: the online working system calls the virtual application client of the terminal device (corresponding to step 2 in FIG. 4);

S13: the terminal device establishes communication with the virtual application server via the virtual application client and launches the application assistant of the virtual application server (corresponding to step 3 in FIG. 4);

S14: the application assistant launches the application and sends the interface of the application to the terminal device 100 for display (corresponding to step 4 in FIG. 4);

S15: whether the application icon clicked by the user is the icon of the CAD application is judged;

S161: in the case where the CAD file is edited, the user clicks on a preset check-in key on the interface of the CAD application to call a relevant check-in interface, and clicks on confirmation after performing the attribute editing on the check-in data;

S162: the CAD file is checked in to the workspace storage device (corresponding to steps 8.1 and 5.1 in FIG. 4);

S171: the user manually creates a non-CAD file, or loads data from the disk Z or any other mapping magnetic disk of the virtual application server and modifies the data and executes the save or save-as operation of the application;

S172: the saved file is stored to the disk Z of the virtual application server, and the save operation of the user triggers the application assistant to return the relevant data to the workspace storage device (corresponding to steps 7.1 and 6.1 in FIG. 4);

S18: the online working system updates list information of the files in the workspace, so that the user can perform operations such as viewing, online editing, sharing, collaboration, etc., next time (corresponding to step 9 in FIG. 4).

Referring to FIG. 4 and FIG. 7B, steps of initiating an online editing function for the non-CAD file in the workspace are as follows:

S21: the user logs in to the online working system via the browser of the terminal device and executes the online editing operation on the non-CAD file in the workspace (corresponding to step 1 in FIG. 4);

S22: the online working system calls the virtual application client of the terminal device (corresponding to step 2 in FIG. 4);

S23: the terminal device establishes communication with the virtual application server via the virtual application client and calls the application assistant of the virtual application server (corresponding to step 3 in FIG. 4);

S24: the application assistant triggers a file transmission operation to transmit the file to be edited from the workspace storage device to the disk Z (corresponding to step 6.2 in FIG. 4);

S25: the application assistant launches the application to load the file to be edited from the disk Z and sends the interface of the application to the terminal device 100 for display (corresponding to step 7.2 and step 4 in FIG. 4);

S26: the user edits the file and executes the save or save-as operation to save the file to the disk Z provided by the virtual application server (corresponding to step 7.1 in FIG. 4);

S27: the save operation of the user triggers the application assistant to return the relevant data to the workspace storage device (corresponding to step 6.1 in FIG. 4);

S28: the online working system updates list information of the files in the workspace, so that the user can perform operations such as viewing, online editing, sharing, collaboration, etc., next time (corresponding to step 9 in FIG. 4).

Referring to FIG. 4 and FIG. 7C, steps of initiating an online editing function via a corresponding CAD file in the workspace in practical operation are as follows:

S31: the user logs in to the online working system via the browser of the terminal device and clicks on the identifier of the CAD application in the workspace (corresponding to step 1 in FIG. 4);

S32: the online working system calls the virtual application client of the terminal device (corresponding to step 2 in FIG. 4);

S33: the terminal device establishes communication with the virtual application server via the virtual application client, and the virtual application server calls the virtual application assistant (corresponding to step 3 in FIG. 4);

S34: the virtual application assistant triggers a file transmission operation, and the CRDE agent program transmits the file to be edited from the workspace storage device to the temporary storage device (corresponding to step 5.2 in FIG. 4);

S35: the virtual application assistant launches the CAD application and sends the interface of the CAD application to the virtual application client (corresponding to step 4 in FIG. 4);

S36: the user manually clicks on a check-out key on the interface of the CAD application to call a check-out related operation interface, and clicks on confirmation to check out the file;

S37: the CAD application loads the file to be edited from the temporary storage device (corresponding to step 8.2 in FIG. 4);

S38: after editing the file, the user manually clicks on the check-in key on the interface of the CAD application to call a check-in related operation interface, and the user clicks on confirmation after editing the attribute of the check-in file;

S39: the CAD application stores the file to the disk Z (corresponding to step 7.1 in FIG. 4);

S310: the CRDE agent program transmits the file from the disk Z to the workspace storage device (corresponding to step 6.1 in FIG. 4);

S311: the online working system updates list information of the files in the workspace, so that the user can perform operations such as viewing, online editing, sharing, collaboration, etc., next time (corresponding to step 9 in FIG. 4).

It should be noted that for the sake of simplifying description, the foregoing method embodiments are all expressed as a series of action combinations, but those skilled in the art should know that the present disclosure is not limited by the described order of actions, because some steps may be performed in other sequences or simultaneously according to the present disclosure. Secondly, those skilled in the art should also know that the embodiments described in the specification are all preferred embodiments, and the actions and modules involved are not necessarily required for the present disclosure.

Based on the above description of the embodiments, those skilled in the art can clearly know that the methods according to the above embodiments can be implemented by virtue of software with necessary universal hardware platform, and can also be implemented by virtue of the hardware. However, the former is the optimal implementation in many cases. Based on this understanding, the technical solutions of the present disclosure can be essentially embodied in the form of software products or the part contributing to the prior art can be embodied in the form of software products. The computer software product can be stored in a computer readable storage medium (such as ROM/RAM, magnetic disks, compact disks, etc.), including a plurality of instructions to enable a terminal device (which can be a mobile phone, a computer, a server, or a network device, etc.) to execute the methods described in various embodiments of the present disclosure.

At least some embodiments of the present disclosure provide a file processing apparatus based on an online working system. For example, the file processing apparatus can be the virtual application server described above, but is not limited thereto. It should be noted that the various modules described below can be implemented as corresponding circuits (such as data processing circuits) and/or corresponding program codes, without being limited in the embodiments of the present disclosure.

FIG. 8 shows a file processing apparatus 800 based on an online working system provided by some embodiments of the present disclosure. The apparatus 800 corresponds to the method provided by the embodiment shown in FIG. 5. Referring to FIG. 8, the apparatus 800 includes: a first interacting module 810, configured to perform an interaction with a virtual application client of a terminal device and to launch an application according to the interaction; a file opening module 820, configured to open a file managed by the online working system based on browser/server architecture in the application, and to send an interface in which the file is opened to the terminal device, wherein the online working system is deployed on an online working system server; and a first file transmitting module 830, configured to transmit the file from a first storage device related to the online working system server to a second storage device related to the virtual application server.

For example, the first interacting module 810 includes: an application launch command receiving sub-module, configured to receive an application launch command for launching the application from the virtual application client via a first agent module; and an application launching sub-module, configured to launch the application via the first agent module in response to the application launch command.

For example, the first file transmitting module 830 includes: a file receiving sub-module, configured to receive file information of the file from the virtual application client via the first agent module; and a first scheduling sub-module, configured to invoke a second agent module via the first agent module to control the first storage device to transmit the file to the second storage device, wherein the second agent module is configured to schedule the first storage device and the second storage device.

For example, the first file transmitting module 830 includes: a second scheduling sub-module, configured to control the first storage device via a second agent module to transmit the file to the second storage device, wherein the second agent module is configured to schedule the first storage device and the second storage device.

For example, the apparatus 800 further includes: a specified type file responding module, configured to cause the online working system server to send an application launch request for launching the application and file information of the file to the virtual application client of the terminal device in response to a trigger operation of a user on a file identifier of the file on a work page of the online working system, wherein the file is a file of a specified type; and the first interacting module 810 includes: a first launch command receiving sub-module, configured to receive an application launch command corresponding to the application launch request from the virtual application client and to launch the application according to the application launch command; and the first file transmitting module 830 includes: a specified type file transmitting sub-module, configured to transmit the file from the first storage device related to the online working system server to the second storage device related to the virtual application server, wherein the second storage device is configured to store the file of the specified type.

For example, the file opening module 820 includes: a check-out sub-module, configured to load the file from the second storage device to the application in response to the operation of the user triggering a plug-in set in the application, wherein the plug-in is configured to check out the file.

For example, the apparatus 800 further includes: an unspecified type file responding module, configured to cause the online working system server to send an application launch request for launching the application and file information of the file to the virtual application client of the terminal device in response to a trigger operation of a user on a file identifier of the file on a work page of the online working system, wherein the file is a file of an unspecified type; and the first interacting module 810 includes: a second launch command receiving sub-module, configured to receive an application launch command corresponding to the application launch request from the virtual application client and to launch the application according to the application launch command; and the first file transmitting module 830 includes: an unspecified type file transmitting sub-module, configured to receive a file start instruction corresponding to the file information from the virtual application client, wherein the file start instruction is used to instruct the virtual application server to open the file, and to transmit the file from the first storage device related to the online working system server to the second storage device related to the virtual application server in response to the file start instruction, wherein the second storage device is configured to store the file of the unspecified type.

For example, the file opening module 820 includes: a file opening sub-module, configured to load the file from the second storage device to the application after the application is launched.

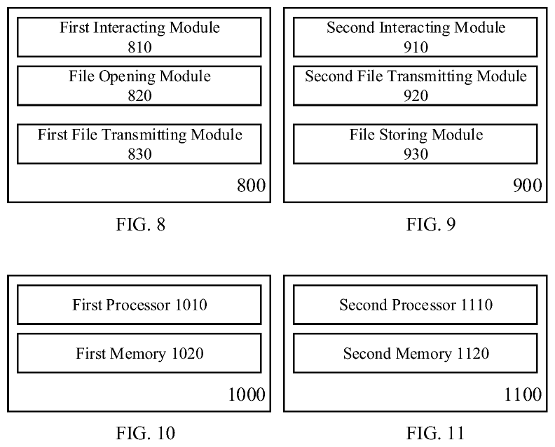

In addition, FIG. 9 shows another file processing apparatus 900 based on an online working system provided by some embodiments of the present disclosure. The apparatus 900 corresponds to the method provided by the embodiment shown in FIG. 6. Referring to FIG. 9, the apparatus 900 includes: a second interacting module 910, configured to perform an interaction with a virtual application client of a terminal device and to send an interface of an application for editing a file to the terminal device; a second file transmitting module 920, configured to transmit the file to a second storage device related to the virtual application server in response to an operation of a user synchronizing the file to the online working system based on browser/server architecture in the application, wherein the online working system is deployed on an online working system server; and a file storing module 930, configured to transmit the file from the second storage device to a first storage device related to the online working system server.

For example, the second file transmitting module 920 includes: a second transmission sub-module, configured to transmit the file from the second storage device to the first storage device via a second agent module, wherein the second agent module is configured to schedule the first storage device and the second storage device.

For example, the file is a file of an unspecified type, and the apparatus 900 saves the file to the second storage device configured for storing the file of the unspecified type in response to an operation of the user utilizing a storage function of the application to save the file.

For example, the file is a file of a specified type, and the apparatus 900 saves the file to the second storage device configured for storing the file of the specified type via the application in response to an operation of the user clicking on a plug-in set in the application, wherein the plug-in is configured to check in the file to the online working system.

For example, in a case of detecting that the file in the second storage device is updated, the apparatus 900 transmits the file from the second storage device to the first storage device via the second agent module.

Therefore, according to the present embodiment, firstly, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. Compared with the solutions of the three online working systems shown in FIGS. 1A-1C, the technical solution of the present embodiment can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the technical solution of the present embodiment can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

FIG. 10 shows a file processing apparatus 1000 based on an online working system provided by some embodiments of the present disclosure. The apparatus 1000 corresponds to the method provided by the embodiment shown in FIG. 5. Referring to FIG. 10, the apparatus 1000 includes: a first processor 1010; and a first memory 1020, coupled with the first processor 1010 and configured to provide the first processor 1010 with instructions for executing the following steps: performing an interaction with a virtual application client of a terminal device and launching an application according to the interaction; and obtaining and opening a file managed by the online working system based on browser/server architecture in the application, and sending an interface in which the file is opened to the terminal device, wherein the online working system is deployed on an online working system server, and the operation of obtaining the file includes: transmitting the file from a first storage device related to the online working system server to a second storage device related to the virtual application server.

For example, the operation that the apparatus 1000 interacts with the virtual application client of the terminal device and launches the application according to the interaction, includes: receiving an application launch command for launching the application from the virtual application client via a first agent module; and launching the application via the first agent module in response to the application launch command.

For example, the operation that the apparatus 1000 transmits the file from the first storage device related to the online working system server to the second storage device related to the virtual application server, includes: receiving file information of the file from the virtual application client via the first agent module; and invoking a second agent module via the first agent module to control the first storage device to transmit the file to the second storage device according to the file information, wherein the second agent module is configured to schedule the first storage device and the second storage device.

For example, the operation that the apparatus 1000 transmits the file from the first storage device related to the online working system server to the second storage device related to the virtual application server, includes: controlling, via a second agent module, the first storage device to transmit the file to the second storage device, wherein the second agent module is configured to schedule the first storage device and the second storage device.

For example, the first memory 1020 is further configured to provide the first processor 1010 with the instructions for processing the following steps: causing the online working system server to send an application launch request for launching the application and file information of the file to the virtual application client of the terminal device in response to a trigger operation of a user on a file identifier of the file on a work page of the online working system, wherein the file is a file of a specified type, and the operation of performing the interaction with the virtual application client of the terminal device and launching the application according to the interaction includes: receiving an application launch command corresponding to the application launch request from the virtual application client, and launching the application according to the application launch command. The operation of transmitting the file from the first storage device related to the online working system server to the second storage device related to the virtual application server includes: transmitting the file from the first storage device related to the online working system server to the second storage device related to the virtual application server, wherein the second storage device is configured to store the file of the specified type.

For example, the operation that the apparatus 1000 opens the file includes: loading the file from the second storage device to the application in response to an operation of the user triggering a plug-in set in the application, wherein the plug-in is configured to check out the file.

For example, the first memory 1020 is further configured to provide the first processor 1010 with the instructions for processing the following steps: causing the online working system server to send an application launch request for launching the application and file information of the file to the virtual application client of the terminal device in response to a trigger operation of a user on a file identifier of the file on a work page of the online working system, wherein the file is a file of an unspecified type, and the operation of performing the interaction with the virtual application client of the terminal device and launching the application according to the interaction includes: receiving an application launch command corresponding to the application launch request from the virtual application client, and launching the application according to the application launch command. The operation of transmitting the file from the first storage device related to the online working system server to the second storage device related to the virtual application server includes: receiving a file start instruction corresponding to the file information from the virtual application client, wherein the file start instruction is used to instruct the virtual application server to open the file; and transmitting the file from the first storage device related to the online working system server to the second storage device related to the virtual application server in response to the file start instruction, wherein the second storage device is configured to store the file of the unspecified type.

For example, the operation that the apparatus 1000 opens the file includes: loading the file from the second storage device to the application after the application is launched.

In addition, FIG. 11 shows another file processing apparatus 1100 based on an online working system provided by some embodiments of the present disclosure. The apparatus 1100 corresponds to the method provided by the embodiment shown in FIG. 6. Referring to FIG. 11, the apparatus 1100 includes: a second processor 1110; and a second memory 1120, coupled with the second processor 1110 and configured to provide the second processor 1110 with instructions for processing the following steps: performing an interaction with a virtual application client of a terminal device and sending an interface of an application for editing a file to the terminal device; transmitting the file to a second storage device related to the virtual application server in response to an operation of a user synchronizing the file to the online working system based on browser/server architecture in the application, wherein the online working system is deployed on an online working system server; and transmitting the file from the second storage device to a first storage device related to the online working system server.

For example, the operation that the apparatus 1100 transmits the file from the second storage device to the first storage device related to the online working system server includes: transmitting the file from the second storage device to the first storage device via a second agent module, wherein the second agent module is configured to schedule the first storage device and the second storage device.

For example, the file is a file of an unspecified type, and the apparatus 1100 saves the file to the second storage device configured for storing the file of the unspecified type in response to an operation of the user utilizing a storage function of the application to save the file.

For example, the file is a file of a specified type, and the apparatus 1100 saves the file to the second storage device configured for storing the file of the specified type via the application in response to an operation of the user clicking on a plug-in set in the application, wherein the plug-in is configured to check in the file to the online working system.

For example, in a case of detecting that the file in the second storage device is updated, the apparatus 1100 transmits the file from the second storage device to the first storage device via the second agent module.

Therefore, according to the present embodiment, firstly, the present solution does not need to install locally the client of the online working system, thereby implementing the lightweight deployment of the online working system. In addition, the application required for the online working is deployed in the virtual application system set on the virtual application server, and operations can be performed locally on the terminal device via the virtual application client. Therefore, it is unnecessary to install the application locally on the terminal device. That is, the online working system of the present solution adopts a combined structure of browser, client and server (i.e., C/B/S combination), realizes the architecture of the online working system in the form of B/S architecture, and implements the deployment of the application in a remote virtual application manner. Compared with the solutions of the three online working systems shown in FIGS. 1A-1C, the technical solution of the present embodiment can deploy the applications with more perfect functions and interactive experience because of not depending on the use of the application deployed in the online working system. Moreover, it is unnecessary to deploy the client of the application on the terminal device, so the application with complete functions can be provided, and the lightweight deployment of the application can be implemented. In addition, in the process of opening the file in the present solution, the file is firstly transmitted from the first storage device related to the online working system server to the second storage device related to the virtual application server, and then the file is opened in the second storage device. Therefore, the application can be utilized reasonably to process the file. Therefore, the technical solution of the present embodiment can quickly and efficiently deploy and utilize the application during the online working process, and the online working efficiency is improved, thereby solving the problems of the three online working systems as shown in FIGS. 1A-1C that the application may not be utilized reasonably to process the file and the online working efficiency is influenced.

In the above embodiments of the present disclosure, the description of each embodiment has its own emphasis. For parts that are not described in detail in an embodiment, reference can be made to related descriptions in other embodiments. It should be understood that, in the embodiments provided in the present disclosure, the disclosed technological content may be implemented in other ways. The apparatus embodiments described above are merely illustrative. For example, the division of the units is only a logical function division, and there may be other divisions in actual implementation. For example, a plurality of units or components may be combined or integrated into another system, or some features may be ignored or not implemented. In addition, the displayed or discussed mutual coupling or direct coupling or communication connection may be indirect coupling or communication connection through interfaces, units or modules, and may be in electrical or other forms. The units serving as separate components may or may not be physically separated, and the component serving as a unit may or may not be a physical unit, that is, the unit may be located in one place or may be distributed on a plurality of network units. Some or all of the units may be selected according to actual needs to achieve the objectives of the solutions of the embodiments. Furthermore, all functional units in various embodiments of the present disclosure may be integrated into one processing unit, or may also be physically separated, or two or more of the functional units may be integrated into one unit. The integrated unit may be implemented in a hardware form, or may also be implemented in the form of a software functional unit. If the integrated unit is implemented in the form of a software functional unit and sold or used as an independent product, it can be stored in a computer readable storage medium. Based on this understanding, the technical solutions of the present disclosure can substantially be embodied in the form of software products, or the part contributing to the prior art or all or some of the technical solutions can be embodied in the form of software products. The computer software product is stored in a storage medium, and includes a plurality of instructions to enable a computer device (which can be a personal computer, a server or a network device, etc.) to execute all or some of the steps of the method described in the embodiments. The foregoing storage medium includes various media capable of storing program codes, such as a USB flash disk, a read-only memory (ROM), a random access memory (RAM), a portable hard disk, a magnetic disk or a compact disk, etc. The above descriptions are only preferred embodiments of the present disclosure. It should be pointed out that various improvements and modifications may be made by those skilled in the art without departing from the concept of the present disclosure, and these improvements and modifications should also be regarded as the protection scope of the present disclosure.

1. A file processing method based on an online working system, applicable to a virtual application server, comprising:
the virtual application server performing an interaction with a virtual application client of a terminal device and launching an application source file managed by an online working system based on browser/server architecture to run a corresponding application on the virtual application server according to the interaction; and
the virtual application server obtaining and opening, in the application, a file managed by the online working system based on browser/server architecture, and sending an interface in which the file is opened to the terminal device,
wherein the online working system is deployed on an online working system server, and the virtual application server obtaining the file comprises:
transmitting, via the virtual application server, the file from a first storage device related to the online working system server to a second storage device related to the virtual application server.

2. The method according to claim 1, wherein the performing the interaction with the virtual application client of the terminal device and launching the application source file managed by the online working system based on browser/server architecture to run the corresponding application on the virtual application server according to the interaction comprises:
receiving an application launch command for launching the application source file managed by the online working system based on browser/server architecture to run the corresponding application on the virtual application server from the virtual application client via a first agent module; and
launching the application source file managed by the online working system based on browser/server architecture to run the corresponding application on the virtual application server via the first agent module in response to the application launch command;
the transmitting, via the virtual application server, the file from the first storage device related to the online working system server to the second storage device related to the virtual application server comprises:
receiving file information of the file from the virtual application client via the first agent module; and
invoking a second agent module via the first agent module to control the first storage device to transmit the file to the second storage device according to the file information, wherein the second agent module is configured to schedule the first storage device and the second storage device.

3. The method according to claim 1, wherein the transmitting, via the virtual application server, the file from the first storage device related to the online working system server to the second storage device related to the virtual application server comprises:
controlling, via a second agent module, the first storage device to transmit the file to the second storage device, wherein the second agent module is configured to schedule the first storage device and the second storage device.

4. The method according to claim 1, further comprising: causing the online working system server to send an application launch request for launching the application source file managed by the online working system based on browser/server architecture to run the corresponding application on the virtual application server and file information of the file to the virtual application client of the terminal device in response to a trigger operation of a user on a file identifier of the file on a work page of the online working system,
wherein the file is a file of a specified type;
the performing the interaction with the virtual application client of the terminal device and launching the application source file managed by the online working system based on browser/server architecture to run the corresponding application on the virtual application server according to the interaction comprises: receiving an application launch command corresponding to the application launch request from the virtual application client, and launching the application source file managed by the online working system based on browser/server architecture to run the corresponding application on the virtual application server according to the application launch command;
the second storage device is configured to store the file of the specified type; and
the opening the file comprises: loading the file from the second storage device to the application in response to an operation of the user triggering a plug-in set in the application, wherein the plug-in is configured to check out the file.

5. The method according to claim 1, further comprising: causing the online working system server to send an application launch request for launching the application source file managed by the online working system based on browser/server architecture to run the corresponding application on the virtual application server and file information of the file to the virtual application client of the terminal device in response to a trigger operation of a user on a file identifier of the file on a work page of the online working system,
wherein the file is a file of an unspecified type;
the performing the interaction with the virtual application client of the terminal device and launching the application source file managed by the online working system based on browser/server architecture to run the corresponding application on the virtual application server according to the interaction comprises: receiving an application launch command corresponding to the application launch request from the virtual application client, and launching the application source file managed by the online working system based on browser/server architecture to run the corresponding application on the virtual application server according to the application launch command;
the transmitting, via the virtual application server, the file from the first storage device related to the online working system server to the second storage device related to the virtual application server comprises:
receiving a file start instruction corresponding to the file information from the virtual application client, wherein the file start instruction is used to instruct the virtual application server to open the file; and
transmitting the file from the first storage device related to the online working system server to the second storage device related to the virtual application server in response to the file start instruction, wherein the second storage device is configured to store the file of the unspecified type;
the opening the file comprises: loading the file from the second storage device to the application after the application is launched.

6. A file processing method based on an online working system, applicable to a virtual application server, comprising:
the virtual application server performing an interaction with a virtual application client of a terminal device and sending an interface for editing a file to the terminal device, of an application running on the virtual application server;
transmitting, via the virtual application server, the file to a second storage device related to the virtual application server in response to an operation of a user synchronizing the file to the online working system based on browser/server architecture in the application, wherein the online working system is deployed on an online working system server and configured to manage an application source file corresponding to the application; and
transmitting, via the virtual application server, the file from the second storage device to a first storage device related to the online working system server.

7. The method according to claim 6, wherein the transmitting, via the virtual application server, the file from the second storage device to the first storage device related to the online working system server comprises:
transmitting the file from the second storage device to the first storage device via a second agent module, wherein the second agent module is configured to schedule the first storage device and the second storage device.

8. The method according to claim 7, wherein the file is a file of an unspecified type,
the transmitting, via the virtual application server, the file to the second storage device related to the virtual application server in response to the operation of the user synchronizing the file to the online working system based on browser/server architecture in the application comprises: saving the file to the second storage device configured for storing the file of the unspecified type in response to an operation of the user utilizing a storage function of the application to save the file; and
the transmitting, via the virtual application server, the file from the second storage device to the first storage device via the second agent module comprises: transmitting the file from the second storage device to the first storage device via the second agent module in a case of detecting that the file in the second storage device is updated.

9. The method according to claim 7, wherein the file is a file of a specified type,
the transmitting, via the virtual application server, the file to the second storage device related to the virtual application server in response to the operation of the user synchronizing the file to the online working system based on browser/server architecture in the application comprises: saving the file to the second storage device configured for storing the file of the specified type via the application in response to an operation of the user clicking on a plug-in set in the application, wherein the plug-in is configured to check in the file to the online working system; and
the transmitting, via the virtual application server, the file from the second storage device to the first storage device via the second agent module comprises: transmitting the file from the second storage device to the first storage device via the second agent module in a case of detecting that the file in the second storage device is updated.

10. A file processing apparatus based on an online working system, applicable to a virtual application server, comprising:
a first interacting module, configured to perform an interaction with a virtual application client of a terminal device and to launch an application source file managed by the online working system based on browser/server architecture to run a corresponding application on the virtual application server according to the interaction;
a file opening module, configured to open, in the application, a file managed by the online working system based on browser/server architecture, and to send an interface in which the file is opened to the terminal device, wherein the online working system is deployed on an online working system server; and
a first file transmitting module, configured to transmit the file from a first storage device related to the online working system server to a second storage device related to a virtual application server.

11. A file processing apparatus based on an online working system, comprising:
a first processor; and
a first memory, coupled with the first processor, and configured to provide the first processor with an instruction for executing the method according to claim 1.

12. A file processing apparatus based on an online working system, comprising:
a second processor; and
a second memory, coupled with the second processor, and configured to provide the second processor with an instruction for executing the method according to claim 6.

13. A non-transitory storage medium, comprising a program stored thereon, wherein upon the program being run by a processor, the method according to claim 1 is executed by the processor.

14. A non-transitory storage medium, comprising a program stored thereon, wherein upon the program being run by a processor, the method according to claim 6 is executed by the processor.
